(19) United States
(12) Patent Application Publication
(10) Pub. No.: US 2003/0131839 A1
(43) Pub. Date: Jul. 17, 2003

(54) Drive unit for a chip-removing tool machine

(76) Inventors: Andreas Steiner, Tiefengraben (AT); Bernhard Brehm, Calw/Stammheim (DE)

Correspondence Address: McGlew & Tuttle, Scarborough Station, Scarborough, NY, 10510-0827, US

(21) Appl. No.: 10/297,902

(22) PCT Filed: Jun. 7, 2001
(86) PCT No.: PCT/EP01/06488

(30) Foreign Application Priority Data
Jun. 14, 2000 (DE) 200 10 531.0

(51) Int. Cl. B28D 1/04

(52) U.S. Cl. 125/13.01; 125/16.03

(57) ABSTRACT

The invention relates to a drive unit (3) for a chip-removing machine tool, especially a sawing, cutting-off or grinding machine for machining concrete, stone, wood or metal. The drive unit (3) can be connected to a tool (2) and comprises a movement unit (8) with an output side swivel arm (9) and a base unit (12). The tool drive (4), which is composed of an electric motor and a gear unit, is arranged in the housing (10) of the swivel arm (9) by means of an integrated bearing. At least one actuating drive (19, 20) which is used to rotate the swivel arm (9) and to move the base unit (12) in a travelling manner can be arranged in the base unit (12). An integrated liquid cooling device (32) can be provided for the drives (4, 19, 21).

The present invention pertains to a drive unit for a machining unit, especially a sawing, cutting-off or grinding machine for processing concrete, stone, wood or metal with the features described in the preamble of the principal claim.

Such machining units with an integrated drive unit have been known from practice. The drive unit is usually rigidly connected to the tool. The drive unit has a tool drive as well as a multiaxial moving unit, which comprises an output-side swivel arm near the tool and a mostly linearly displaceable base unit. The tool drive is arranged at the base unit, and the driving forces must be transmitted up to the tool beyond the swivel arm by means of gear mechanisms. This requires a great design effort and large space, and kinematic problems arise as well.

The object of the present invention is to propose a better drive unit.

This object is accomplished by the present invention with the features described in the principal claim.

In the drive unit being claimed, the tool drive is arranged in or at the swivel arm. As a result, the tool drive can be moved along during the rotary movements of the swivel arm. Complicated deflecting gear mechanisms can be eliminated. In addition, the drive losses are reduced. Due to the arrangement of the tool drive near the tool, the transmission of forces is also much more direct and burdened by fewer tolerance problems, undesired elastic properties, etc. In addition, the design effort is lower, and, in particular, the overall size of the drive unit can be reduced.

In the preferred embodiment, the drive unit is designed as a replaceable drive module that can be used for different tool machines. The tool machines can be simplified and made less expensive as a result. In addition, the weight can be reduced due to the possibility of separation and taking apart. The handling and the maintenance are likewise simplified. The drive module can be used at different tool machines as a result. Special advantages arise in the areas of saws, cutting-off or grinding machines for the processing of concrete or stone. The tools used for this purpose may be of a completely different nature. Both a cable saw and a disk saw or a disk saw or a cutting-off saw can be operated with the drive module. A suitable standardized tool holding fixture, preferably in the form of a standardized change-over coupling, ensures simple tool change.

As an alternative, the drive unit may also be permanently integrated within the tool machine. In the simplest embodiment, it comprises the tool drive, the multiaxial moving unit and adjusting drives. A suitable guide, especially a linear guide rail, may be present for the moving unit. This guide may also be part of the drive unit and especially of the replaceable drive module. With a suitable short base length and suitable connection possibilities with bearing block and mount, a correspondingly standardized guide can then offer standardized possibilities of connection to the different basic components of the tool machine. Depending on the range of tasks, the moving unit may also be fixed and locked on the tool machine by means of one or more suitable fixing means, especially clamping means. The drive unit or the drive module can then function as a stationary drive.

The drive unit may have an integrated cooling means, which is operated with fluidic cooling agents, such as water, but also with cutting oils or special cooling liquids. Despite their being encapsulated in the housing and their small size, the drive units can be optimally cooled by this cooling, which preferably has both an open cooling circuit and a closed cooling circuit led to the tool. It is favorable for this purpose for the cooling lines to be led in the manner of a cooling cage around the motors and the gear mechanisms.

Additional advantageous embodiments of the present invention are described in the subclaims.

The present invention is schematically shown in the drawing as an example. Specifically,

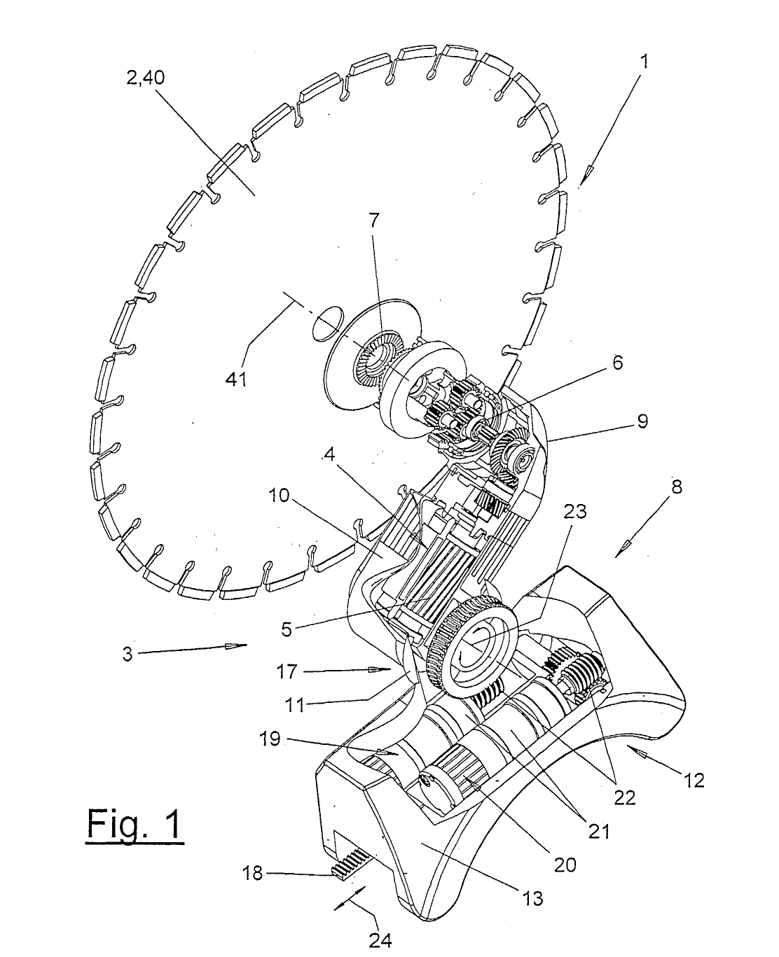

FIG. 1 shows a partially cut-away machining unit with a drive unit in a partially cut-away exploded view,

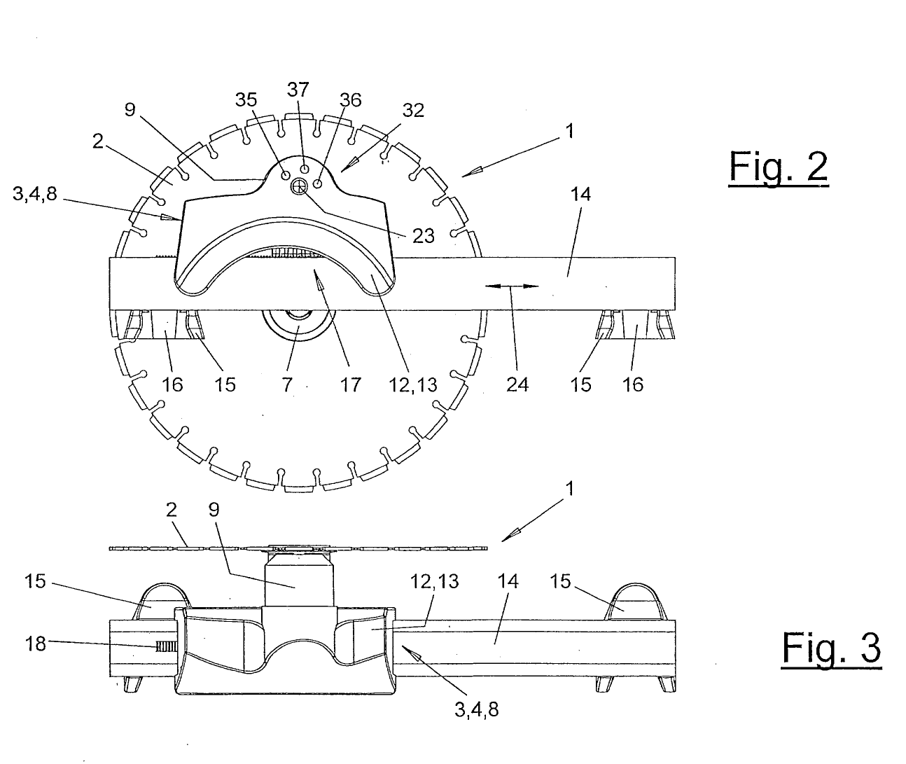

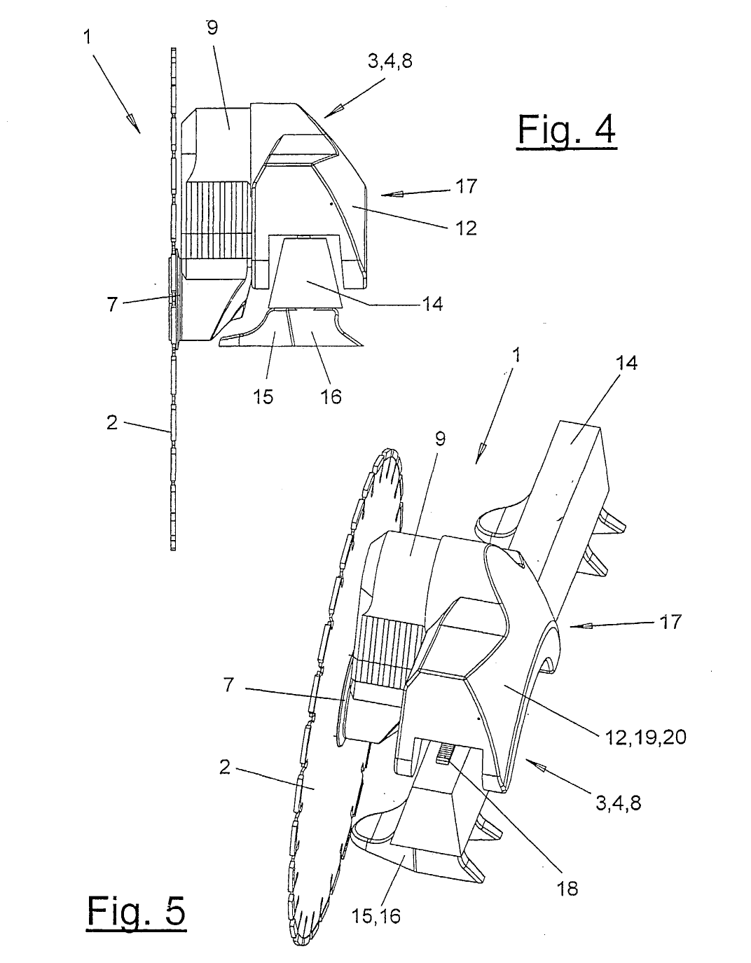

FIGS. 2 through 5 show different views of the tool machine according to FIG. 1,

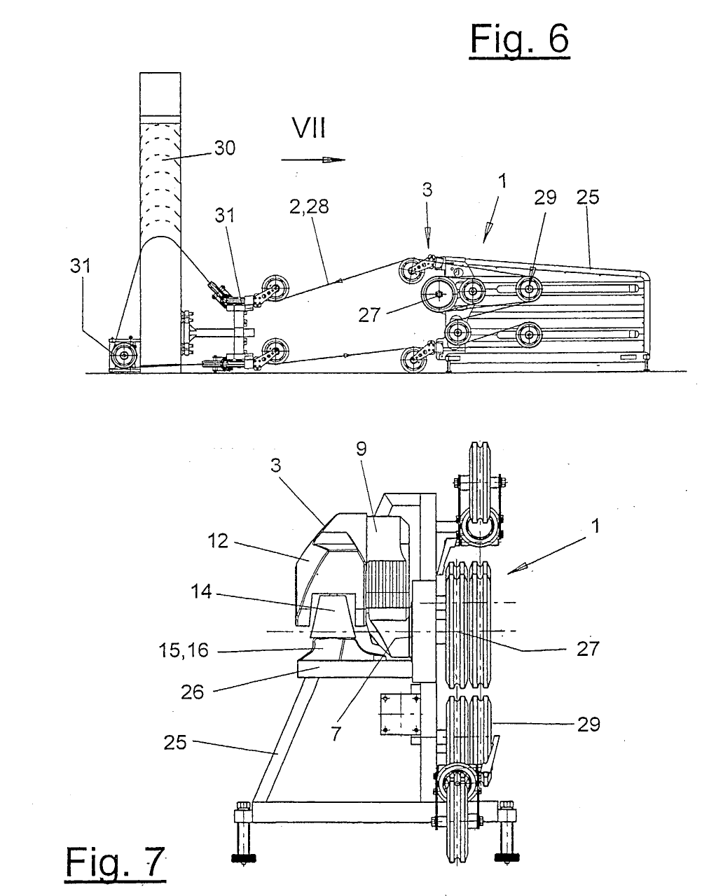

FIGS. 6 and 7 show a side view and a front view according to arrow VII of variant of the tool machine as a cable saw, and

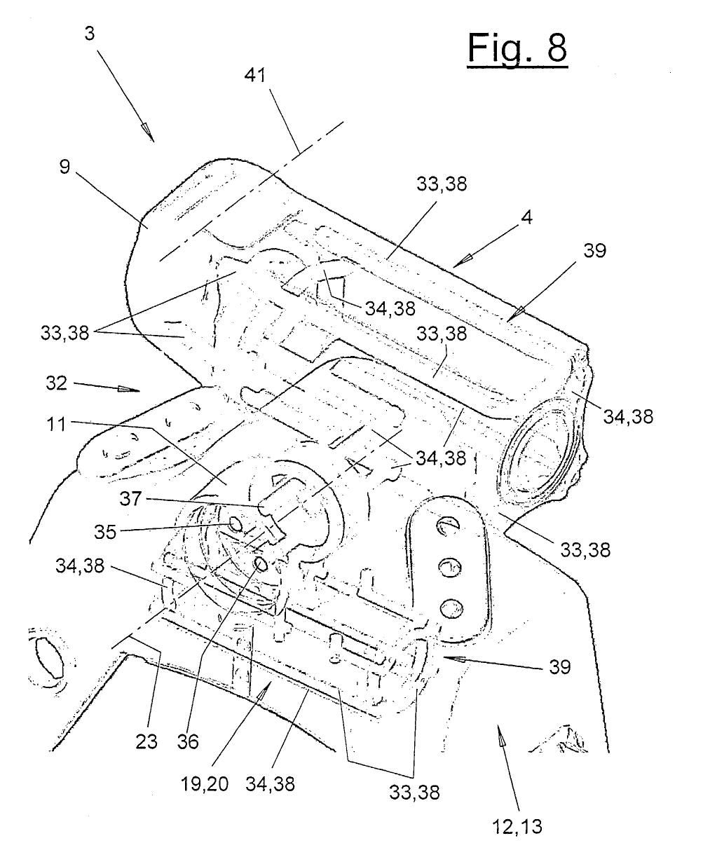

FIG. 8 shows a perspective view of the drive unit with an integrated cooling means.

The drawings show a machining unit (1), which is designed as a disk or cutting-off saw in the exemplary embodiment according to FIGS. 1 through 5 and as a cable saw in the exemplary embodiment according to 6 and 7.

In the embodiment as a cutting-off saw, the tool (2) comprises a rotating, disk-shaped saw blade (40). In the case of the cable saw, the tool (2) is designed as a circulating endless saw cable (28). In other variants, not shown, the tool (2) may have any other form and may be designed, e.g., as a grinding tool, cutting or cutting-off tool.

The tool machine (1) is preferably designed as a cutting machine, removing the material being processed with the tool (2). A preferred field of use of the tool machine (I) lies in the processing of concrete, stone, marble, ceramics or other similar stone materials. However, other materials, such as metal, wood or plastic can be processed as well.

The tool machine (1) has a drive unit (3) for driving and moving the tool (2). This drive unit (3) may be optionally integrated within the tool machine (1) as a fixed component or it may be designed as a replaceable drive module.

The drive unit (3) comprises a tool drive (4) and a multiaxial, motor-driven moving unit (8). The unit (8) comprises a swivel arm (9), to which the tool (2) is detachably fastened via a suitable tool holding fixture (7), preferably a standardized quick change coupling for different tools. Furthermore, the moving unit (8) also comprises a base unit (12), which is designed as a linear displacing unit in this exemplary embodiment being shown.

In the embodiment being shown, the moving unit (8) has two movement axes (23, 24), namely, the axis of rotation (23) of the swivel arm (9) and the linear travel axis (24) of the displacing unit (12). The axis of rotation (23) is preferably directed at right angles to the travel axis (24). For example, a stone saw can cut joints of any desired length and depth as a result, the depth of the to joint being determined by the angle of rotation of the swivel arm (9) and the length of the joint being determined by the amount of displacement of the displacing unit (12).

In other, modified embodiments, the moving unit (8) may have additional or other axes of movement, and the base unit itself may also comprise a plurality of parts correspondingly with a plurality of movement axes. For example, the base unit (12) may also be designed as a one-part or multipart pivoting unit, where the second movement axis (24) is likewise an axis of rotation.

The tool drive (4), which sets the tool (2) into a rotating or circulating movement or into any other desired type of movement around a tool axis of rotation (41), is arranged in the area of the swivel arm (9). In the embodiment being shown, the tool drive (4) is arranged inside the swivel arm housing (10) between the axis of rotation (23) of the said housing and the tool axis of rotation (41). Integrated mounting in the housing (13), which is closed all around, is provided for this purpose.

In another variant, not shown, the tool drive (4) may also be arranged in another area at the swivel arm (9) and, e.g., on the outer side of the said swivel arm. The swivel arm (9) may also have any desired and suitable cross-sectional shape for this purpose, e.g., a partially open housing or a single rod shape. The integrated mounting in the hollow housing (10) shown has the advantage that it protectively surrounds the tool drive (4) on all sides.

The tool drive (4) comprises an electric drive motor (5) and a multistep gear mechanism (6). In the embodiment being shown, the gear mechanism is designed as a miter gear, whose output axis or tool axis of rotation (41) extends at right angles to the longitudinal axis of the swivel arm (9). As a result, the tool (2) directed along the travel axis (24) can be moved along the travel axis (24) and additionally pivoted up and down in a plane directed along the travel axis (24). This arrangement may also be selected differently, in which case, e.g., the output axis extends coaxially with the swivel arm (9).

The electric drive motor and the integrated gear mechanism (6) are preferably designed corresponding to DE-G 298 06 147 and have a high performance with a small space requirement. However, as an alternative, the tool drive (4) may also have another desired design. However, other motors may also be used here instead of an electric motor. A gear mechanism (6) may also possibly also be eliminated.

The base unit (12) or travel unit comprises a housing (13), which accommodates the adjusting drives (19, 20) for the movement axes (23, 24) and the pivoting movement of the swivel arm as well as the displacing movement of the base unit (12). FIG. 1 shows these parts in a broken-away exploded view. In the embodiment being shown, the adjusting drive (19) moves the swivel arm (9) and the adjusting drive (20) moves the base unit (12).

The adjusting drives (19, 20) comprise each a motor operator (21), preferably an electric motor, and a gear mechanism (22), e.g., a worm gear mechanism. A guide (14), e.g., a guide rail, on which a suitable output means (18), e.g., a toothed rack, is provided for engaging the driven wheel of the adjusting drive (20), is provided for the displacing movement of the base unit (12). The adjusting drive (19) rotates a worm gear on the swivel arm (9) via its worm shaft. The swivel arm (9) is connected for this purpose to the base unit (12) via a hollow drag bearing (11) in a suitable manner, the worm gear surrounding the bearing (11) on the outside.

In a variant of the embodiment being shown, the adjusting drive for the swivel arm (9) may also be accommodated in or at the swivel arm (9) in the case of corresponding space conditions. In the case of a multipart base unit, a plurality of adjusting drives (19, 20) may also be correspondingly present, and they may also be designed and arranged correspondingly differently.

The base unit (12) is connected to the guide (14) via a suitable sliding or rolling mount. A very great variety of design possibilities are available for this as well. An encompassing positive-locking guide, which permits the mobility of the base unit (12) in the travel axis (24) only, is preferably present.

The guide rail (14) has one or more bearing blocks (15) or other connection possibilities, with which it can be fastened to the tool machine (1). As an alternative, the guide (14) may also be integrated within the machine frame of the tool machine (1). The guide (14) may also be fastened in another area externally, e.g., to a workpiece. Suitable mounts (16) for detachable fastening and for replacement are preferably present at the bearing blocks (15).

In the preferred embodiment, the drive unit (3) is designed as a replaceable drive module. It comprises the guide (14) and is replaced together with this guide (14). Detachable fastening is possible via the bearing blocks (15) and the mounts (16). It is recommended in this case to provide the guide rail (14) with a short standard length and to use it as a result as a kind of frame or supporting mount of the drive unit (3). The short base rail may be extended with additional rail parts on one side or on both sides as needed, and these extension parts may be arranged, e.g., at the machine frame of the tool machine (1). Corresponding front-side rail connections are now also possible for this to make a continuous, long guide rail.

The drive unit (8) preferably has one or more fixing means (17), not shown more specifically, with which the movement axes (23, 24) can be fixed. These are, e.g., clamping means at the bearing (11) and at the housing (13) and at the guide (14). The moving unit (8) can be locked by means of the fixing means (17), so that the drive unit (3) or the drive module can function as a stationary drive.

In the blade saw or cutting-off saw shown in FIGS. 1 through 5, the tool machine (1) may be designed as a stationary machine. The feed motion for the saw blade (40) and the depth of cut are determined [by—“aus” missing on p. 9, line 10 of German original is misplaced into line 21—Tr.Ed.] the axis of rotation (23). However, the leaf or cutting-off saw may also be designed as a joint cutter, wherein the amount of displacement is determined by the linear movement axis (24) of the moving unit (8) in conjunction with a correspondingly long guide (14). The guide (14) may be fastened to the machine frame of the tool machine (1) or to the workpiece. As an alternative, the saw (1) designed as a joint cutter for longer travels may also be arranged on a vehicle. The drive unit (3) is fastened now on the vehicle with a short guide rail (14) and with the displacing unit (12) and the displacement axis (24) blocked.

In the cable saw shown in FIGS. 6 and 7, the drive unit (3) or the drive module is fastened at the machine frame (25) to a suitable base (26) or another mount. In the case of the cable saw (1), the drive unit (3) is used as a stationary drive for both movement axes (23, 24) with the fixing means (17) blocked. The swivel arm (9) with the tool drive (4) is connected to the drive roller (27) via the tool holding fixture (7) or quick change coupling. A reducing gear may be inserted. The saw cable (28) is guided at the machine frame (25) via a cable guide (29) with a plurality of stationary and movable deflecting rollers and a displaceable cable storage unit and is driven to perform a circulating movement via the drive roller (27).

Separating cuts are made with the cable saw (1) in walls (30), and the sawing cable (28) packed with abrasive particles can be brought into the necessary angular positions. Aside from the drive unit (3), the cable saw may have any desired design. It is preferably designed corresponding to DE-G 298 21 386.

In the preferred embodiment, the drive unit (3) has an integrated cooling means (32), which is operated with suitable liquid cooling agents. The cooling agents may be water in the simplest case. However, they may also consist of special circulating cooling agents. In another variant, the cooling agent may also be cutting lubricant or rinsing agent for the tool (2).

FIG. 8 shows the cooling means (32) in detail. Parts of the cooling means are shown in a side view in FIG. 2.

The cooling means (32) has an open cooling circuit (33), which is led to the tool (2) and escapes there. The cooling liquid is a suitable cutting lubricant or rinsing agent for the tool (2) in this case. The open cooling circuit (33) has a feed (35), which is arranged on the housing (13) of the base unit (12) and to which supply tubes can be connected in a suitable manner.

In the preferred embodiment, the cooling means (32) has a closed cooling circuit (34), which has a feed (36) and a return (37), both of which are arranged in the vicinity of the above-mentioned feed (35) on the housing (13).

As an alternative, only one open cooling circuit (35) or only one closed cooling circuit (34) may be present in a variant of the embodiment shown. A plurality of such cooling circuits may optionally also be arranged in parallel.

In the embodiment being shown, the cooling circuits (33, 34) comprise cooling lines (38), preferably cooling pipes, which are laid inside the housing (13) of the base unit (12) and the housing (10) of the swivel arm (9). The cooling means (32) cools mainly the tool drive (4) and the adjusting drives (19, 20). The cooling lines (38) are led for this purpose such that they surround the tool drive (4) and the adjusting drives (19, 20) on a plurality of sides and form a cooling cage (39) each. The cooling cages (39) preferably surround not only the motors (5, 21) but also the gear mechanisms (6, 22).

The feeds (35, 26) [sic—Tr.Ed.] and the return (37) are preferably arranged in the area of the axis of rotation (23) of the swivel arm (9) and are led with their adjoining cooling lines (38) through the bearing (11). The bearing (11) has a correspondingly large diameter for this purpose. The cooling lines (38) may form a plurality of loops in the area of the bearing in order to offer an additional cooling effect in this area.

As is illustrated in FIG. 8, the cooling cages (39) are formed by straight line sections extending along the drives (4, 19, 20) and front-side connection sections. As a result, at least one such line section is located at the four longitudinal edges of the drives (4, 19, 20). A plurality of line sections extending in parallel are also sometimes present at these edge areas. The two cooling circuits (33, 34) may complement each other, each cooling circuit (33, 34) forming another cooling section of the cooling cage (39). However, the cooling circuits (33, 34) may also extend in some areas in parallel to one another on the said side of the cage. As a result, intensification of the cooling capacity is possible at one or more areas of the drives (4, 19, 20). As a result, the cooling effect can be dimensioned specifically for local generation of heat and increased cooling demand. In addition, the accessibility to the drives (4, 19, 20) for maintenance and mounting purposes is preserved due to the formation of cooling cages (39).

Various variants of the embodiments shown are possible. The drive unit (3) may be limited, e.g., to the tool drive (4) and the moving unit (8), and the guide (14) does not belong to it any longer. The interface for the assembly and the disassembly of the drive unit (3) is now located at the guide (14), and this belongs now to the frame or to the basic structure of the tool machine (1). The drive unit (3) is now placed on the guide (14) with the base unit (12) for assembly. The use and arrangement of the cooling means (32) is also variable. If the housing is dimensioned properly and there is sufficient outside air cooling, the fluidic cooling means (32) may also be eliminated. Furthermore, the cooling means (32) may be integrated within the housing wall. Its dimensioning and shape are also variable. Instead of rod-shaped cooling cages (39), it is also possible to use other shapes of the cooling means (32), e.g., plate coolers.

### LIST OF REFERENCE NUMBERS

1 Machining unit, saw, cable saw

2 Tool

3 Drive unit, drive module

4 Tool drive, rotary drive

5 Drive motor

6 Gear mechanism

7 Tool holding fixture, coupling

8 Moving unit

9 Swivel arm

10 Housing

11 Bearing

12 Base unit, displacing unit

13 Housing

14 Guide, guide rail

15 Bearing block

16 Mount

17 Fixing means, clamping means

18 Output means

19 Adjusting drive

20 Adjusting drive

21 Motor operator

22 Gear mechanism

23 Movement axis, axis of rotation

24 Movement axis, displacement axis

25 Machine frame

26 Base

27 Drive roller

28 Sawing cable

29 Cable guide

30 Wall

31 Deflecting device

32 Cooling means

33 Open cooling circuit

34 Closed cooling circuit

35 Feed for open cooling circuit

36 Feed for closed cooling circuit

37 Return for closed cooling circuit

38 Cooling line

39 Cooling cage

40 Sawing blade

41 Output axis, tool axis of rotation

1. Drive unit for a said machining unit (1), especially a sawing, cutting-off or grinding machine for processing concrete, stone, wood or metal, wherein the said drive unit (3) can be connected to a said tool (2) and has a said tool drive (4) as well as a said moving unit (8) with preferably one or more said additional movement axes (23, 24), characterized in that the said tool drive (4) is arranged in or at the said swivel arm (9).

2. Drive unit in accordance with claim 1, characterized in that the said housing (10) of the said swivel arm (9) has an integrated mount for a said electric drive motor (5) and a said highly reducing gear mechanism (6) of the said tool drive (4).

3. Drive unit in accordance with claims 1 or 2, characterized in that the said drive unit (3) is designed as a replaceable drive module that can be used for said different tool machines (1).

4. Drive unit in accordance with claim 1, 2 or 3, characterized in that the said swivel arm (9) is mounted on a said uniaxially or multiaxially movable base unit (12), preferably a said displacing unit (11).

5. Drive unit in accordance with one of the above claims, characterized in that one or more said adjusting drives (19, 20) are arranged in the said housing (13) of the said base unit (12) for the movements of the said moving unit (8).

6. Drive unit in accordance with one of the above claims, characterized in that the said base unit (12) is mounted movably on a said guide (14) and can be locked with a said fixing means (17).

7. Drive unit in accordance with one of the above claims, characterized in that the said guide (14) has a short base length and at least one said bearing block (15).

8. Drive unit in accordance with one of the above claims, characterized in that the said bearing block (15) has a said mount (16) for detachable fastening to a support frame.

9. Drive unit in accordance with one of the above claims, characterized in that the drive unit has a said integrated fluidic cooling means (32).

10. Drive unit in accordance with one of the above claims, characterized in that the said cooling means (32) has a said open cooling circuit (33), which is led to the said tool (2).

11. Drive unit in accordance with one of the above claims, characterized in that the said cooling means (32) has a said closed cooling circuit (34).

12. Drive unit in accordance with one of the above claims, characterized in that the said cooling circuits (33, 34) with their said cooling lines (38) surround the said tool drive (4) and the said adjusting drives (19, 20) on a plurality of sides and form said cooling cages (39).

13. Drive unit in accordance with one of the above claims, characterized in that the said feeds (35, 36) and the said drain (34) [sic—Tr.Ed.] of the said cooling lines (38) are connected to the said housing (13) of the said base unit (12), and the said cooling lines (38) are led through the said bearing (11) of the said swivel arm (9).
